(19) United States
(12) Patent Application Publication
(10) Pub. No.: US 2025/0245573 A1
(43) Pub. Date: Jul. 31, 2025

(54) DURATION PREDICTION MODEL TRAINING

(71) Applicant: TENCENT TECHNOLOGY (SHENZHEN) COMPANY LIMITED, Shenzhen (CN)

(72) Inventor: Yuzhao CHEN, Shenzhen (CN)

(73) Assignee: TENCENT TECHNOLOGY (SHENZHEN) COMPANY LIMITED, Shenzhen (CN)

(21) Appl. No.: 19/183,763

(22) Filed: Apr. 18, 2025

Related U.S. Application Data
(63) Continuation of application No. PCT/CN2024/074237, filed on Jan. 26, 2024.

(30) Foreign Application Priority Data
Mar. 27, 2023 (CN) 202310313468.5

(51) Int. Cl. G06N 20/00

(52) U.S. Cl. CPC G06N 20/00

(57) ABSTRACT

A training sample subset is acquired from a training sample set, the training sample subset includes a plurality of pieces of sample network content having positive samples corresponding to clicked pieces of sample network content and negative samples corresponding to not clicked pieces of sample network content. A target quantity is determined based on a quantity of the positive samples. By using an auxiliary model that is to be trained, a duration label prediction is performed on selected negative samples of the target quantity obtain dummy duration labels respectively associated with the selected negative samples. True duration labels respectively associated with the plurality of pieces of sample network content are acquired. A duration prediction model and the auxiliary model are trained based on the selected negative samples, the dummy duration labels, the plurality of pieces of sample network content, and the true duration labels.

### RELATED APPLICATIONS

The present application is a continuation of International Application No. PCT/CN2024/074237, filed on Jan. 26, 2024, which claims priority to Chinese Patent Application No. 202310313468.5, filed on Mar. 27, 2023. The entire disclosures of the prior applications are hereby incorporated by reference.

### FIELD OF THE TECHNOLOGY

This application relates to the field of computer technologies, including a duration prediction model training.

### BACKGROUND OF THE DISCLOSURE

With the development of computer technologies, an application program can predict click-through rates of a plurality of pieces of network content based on a click prediction model, and then recommend network content, such as videos, audio, news information, and goods, to users based on a sorting result of the click-through rates, to satisfy different interests of the users. However, the foregoing method is not applicable to a case in which predicted click-through rates of a plurality of pieces of network content are identical. Therefore, how to sort network content having a same predicted click-through rate is a technical problem that needs to be solved.

In the related art, a duration prediction model is usually introduced based on the click prediction model. Browsing duration of network content after the network content is clicked is predicted by using the duration prediction model while a click-through rate of the network content is predicted, and then the network content is sorted according to prediction results of the browsing duration of the network content.

However, exposed network content includes clicked network content and unclicked network content, and a quantity of unclicked network content is far greater than a quantity of clicked network content. Therefore, the related art has problems of a small training data volume, a sample selection deviation, and gradient update conflict, leading to low accuracy of duration prediction.

### SUMMARY

Embodiments of this disclosure provide a duration prediction model training method and apparatus, a computer device, and a storage medium.

Some aspects of the disclosure provide a method of duration prediction model training. In some examples, at least a training sample subset is acquired from a training sample set, the training sample subset includes a plurality of pieces of sample network content, and the plurality of pieces of sample network content includes positive samples corresponding to clicked pieces of sample network content and negative samples corresponding to not clicked pieces of sample network content. A target quantity is determined based on a quantity of the positive samples in the plurality of pieces of sample network content. By using an auxiliary model that is to be trained, a duration label prediction is performed on selected negative samples of the target quantity from the training sample set to obtain dummy duration labels respectively associated with the selected negative samples, a dummy duration label associated with a negative sample in the selected negative samples indicating a prediction of whether a browsing duration of the negative sample after the negative sample is clicked is greater than a duration threshold. True duration labels respectively associated with the plurality of pieces of sample network content are acquired, a true duration label associated with a piece of sample network content in the plurality of pieces of sample network content indicates whether a browsing duration of the piece of sample network content after the piece of sample network content is clicked is greater than the duration threshold. A duration prediction model and the auxiliary model are trained based on the selected negative samples, the dummy duration labels respectively associated with the selected negative samples, the plurality of pieces of sample network content, and the true duration labels respectively associated with the plurality of pieces of sample network content. The duration prediction model is configured to predict a probability that a browsing duration of a to-be-evaluated piece of sample network content after the to-be-evaluated piece of sample network content is clicked is greater than the duration threshold.

Some aspects of the disclosure provide an apparatus of duration prediction model training. The apparatus includes processing circuitry (e.g., one or more processors) configured to acquire at least a training sample subset from a training sample set, the training sample subset comprising a plurality of pieces of sample network content. The plurality of pieces of sample network content includes positive samples corresponding to clicked pieces of sample network content and negative samples corresponding to not clicked pieces of sample network content. The processing circuitry is also configured to determine a target quantity based on a quantity of the positive samples in the plurality of pieces of sample network content, and perform, by using an auxiliary model that is to be trained, a duration label prediction on selected negative samples of the target quantity from the training sample set to obtain dummy duration labels respectively associated with the selected negative samples. A dummy duration label associated with a negative sample in the selected negative samples indicates a prediction of whether a browsing duration of the negative sample after the negative sample is clicked is greater than a duration threshold. The processing circuitry is also configured to acquire true duration labels respectively associated with the plurality of pieces of sample network content. A true duration label associated with a piece of sample network content in the plurality of pieces of sample network content indicates whether a browsing duration of the piece of sample network content after the piece of sample network content is clicked is greater than the duration threshold. The processing circuitry is further configured to train a duration prediction model and the auxiliary model based on the selected negative samples, the dummy duration labels respectively associated with the selected negative samples, the plurality of pieces of sample network content, and the true duration labels respectively associated with the plurality of pieces of sample network content. The duration prediction model is configured to predict a probability that a browsing duration of a to-be-evaluated piece of sample network content after the to-be-evaluated piece of sample network content is clicked is greater than the duration threshold.

In an aspect, a duration prediction model training method is provided, which is performed by a computer device and includes acquiring a training sample subset obtained by dividing a training sample set, the training sample subset including a plurality of pieces of sample network content, and the plurality of pieces of sample network content including a positive sample that is clicked and a negative sample that is not clicked. The method includes determining a quantity of positive samples included in the training sample subset, to obtain a target quantity, and performing duration label prediction on a target quantity of negative samples in the training sample set by using a to-be-trained auxiliary model, to obtain dummy duration labels of the target quantity of negative samples, the dummy duration label being configured to indicate prediction of whether browsing duration of the negative sample after the negative sample is clicked is greater than a duration threshold. The method includes acquiring true duration labels of the plurality of pieces of sample network content, and training a duration prediction model and the auxiliary model based on the target quantity of negative samples, the dummy duration labels of the target quantity of negative samples, the plurality of pieces of sample network content, and the true duration labels of the plurality of pieces of sample network content, the true duration label being configured to indicate whether browsing duration of the sample network content after the sample network content is actually clicked is greater than the duration threshold, and the duration prediction model being configured to predict a probability that the browsing duration of the sample network content after the sample network content is clicked is greater than the duration threshold.

In another aspect, a duration prediction model training apparatus is provided, which includes a division module, a prediction module, and a training module. The division module is configured to acquire a training sample subset obtained by dividing a training sample set, the training sample subset including a plurality of pieces of sample network content, and the plurality of pieces of sample network content including a positive sample that is clicked and a negative sample that is not clicked. The prediction module is configured to determine a quantity of positive samples included in the training sample subset, to obtain a target quantity, and perform duration label prediction on a target quantity of negative samples in the training sample set by using a to-be-trained auxiliary model, to obtain dummy duration labels of the target quantity of negative samples, the dummy duration label being configured to indicate prediction of whether browsing duration of the negative sample after the negative sample is clicked is greater than a duration threshold. The training module is configured to acquire true duration labels of the plurality of pieces of sample network content, and train a duration prediction model and the auxiliary model based on the target quantity of negative samples, the dummy duration labels of the target quantity of negative samples, the plurality of pieces of sample network content, and the true duration labels of the plurality of pieces of sample network content, the true duration label being configured to indicate whether browsing duration of the sample network content after the sample network content is actually clicked is greater than the duration threshold, and the duration prediction model being configured to predict a probability that the browsing duration of the sample network content after the sample network content is clicked is greater than the duration threshold.

In another aspect, a computer device is provided, which includes a processor (an example of processing circuitry) and a memory. The memory is configured to store at least one computer program, and the processor loads and executes the at least one computer program to implement the duration prediction model training method according to the embodiments of this disclosure.

In another aspect, a computer-readable storage medium (for example, a non-transitory computer-readable storage medium) is provided, which has at least one computer program stored therein. A processor loads and executes the at least one computer program to implement the duration prediction model training method according to the embodiments of this disclosure.

In another aspect, a computer program product is provided, which includes a computer program. A processor executes the computer program to implement the duration prediction model training method according to the embodiments of this disclosure.

Details of one or more embodiments of this disclosure are provided in the accompanying drawings and descriptions below. Other features, objectives, and advantages of this disclosure become apparent from the description, the drawings, and the claims.

### BRIEF DESCRIPTION OF THE DRAWINGS

FIG. 1 is a schematic diagram of an implementation environment of a duration prediction model training method according to an embodiment of this disclosure.

FIG. 2 is a flowchart of a duration prediction model training method according to an embodiment of this disclosure.

FIG. 3 is a flowchart of another duration prediction model training method according to an embodiment of this disclosure.

FIG. 4 is a schematic structural diagram of an auxiliary model according to an embodiment of this disclosure.

FIG. 5 is a schematic structural diagram of a click prediction model and a duration prediction model according to an embodiment of this disclosure.

FIG. 6 is a block diagram of a duration prediction model training apparatus according to an embodiment of this disclosure.

FIG. 7 is a block diagram of another duration prediction model training apparatus according to an embodiment of this disclosure.

FIG. 8 is a structural block diagram of a terminal according to an embodiment of this disclosure.

FIG. 9 is a schematic structural diagram of a server according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In this disclosure, the terms “first”, “second”, and the like are used for distinguishing between same items or similar items that have basically same effects and functions. “First”, “second”, and “nth” do not have logical or time sequence dependency, and are not intended to limit quantity and an execution sequence.

In this disclosure, the term “at least one” means one or more, and “a plurality of” means two or more.

In addition, information (including but not limited to user device information, user personal information, and the like), data (including but not limited to data for analysis, stored data, displayed data, and the like), and signals involved in this disclosure are all authorized by a user or fully authorized by various parties, and collection, use, and processing of related data need to comply with relevant laws, regulations, and standards of relevant countries and regions. For example, a training sample set and true duration labels involved in this disclosure are obtained under full authorization.

### Terms Involved In This Disclosure Are Explained Below

Artificial intelligence (AI): it involves a theory, a method, a technology, and an application system that use a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning (ML)/deep learning.

ML: it is a multi-field interdiscipline, and relates to a plurality of disciplines such as the probability theory, statistics, the approximation theory, convex analysis, and the algorithm complexity theory. ML specializes in studying how a computer simulates or implements a human learning behavior to acquire new knowledge or skills, and reorganize an existing knowledge structure to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

Label: it is annotated data on which deep neural network training depends, for example, any one of “belongs to/does not belong to” represented by “0/1”.

Batch: model training is a process of a plurality of iterations, a batch of data is taken as an input of a model in each iteration, and such a batch of data is referred to as a batch.

Embedding: it is a numeric vector composed of a plurality of floating-point numbers, which describes various attributes and properties of an object or a user in a high-dimensional space.

Back propagation algorithm: it is a basic training algorithm of a deep neural network, which refers to a process of calculating a direction and magnitude of adjustment and change of a model parameter according to a difference between a prediction result of the model and a true value.

A duration prediction model training method provided in the embodiments of this disclosure may be performed by a computer device. In some embodiments, the computer device is a terminal or a server. An implementation environment of the duration prediction model training method provided in the embodiments of this disclosure is described below by using an example in which the computer device is a server. FIG. 1 is a schematic diagram of an implementation environment of a duration prediction model training method according to an embodiment of this disclosure. Refer to FIG. 1. The implementation environment includes a terminal 101 and a server 102. The terminal 101 and the server 102 are directly or indirectly connected by using a wired or wireless communication protocol, which is not limited in this disclosure.

In some embodiments, the terminal 101 is a smartphone, a tablet computer, a notebook computer, a desktop computer, a smart speaker, a smart watch, a smart voice interaction device, a smart household appliance, an on-board terminal, or the like, but is not limited thereto. An application program that can display network content is installed on the terminal 101. The application program may be a social application program, an information application program, a shopping application program, or the like, which is not limited in the embodiments of this disclosure. Exemplarily, the terminal 101 acquires, by using the social application program, a plurality of pieces of network content browsed by a user. The network content may be multimedia resources such as videos, articles, and pictures. The terminal 101 can upload the plurality of pieces of network content to the server 102, and the server 102 trains a duration prediction model based on the plurality of pieces of network content.

Those skilled in the art may learn that there may be more or fewer terminals. For example, there is only one terminal, or there are dozens or hundreds of terminals, or more terminals. A quantity of terminals and a device type are not limited in the embodiments of this disclosure.

In some embodiment, the server 102 is an independent physical server, or a server cluster or distributed system composed of a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform. The server 102 is configured to provide a backend service for the application program supporting network content collection. Exemplarily, the server 102 receives the plurality of pieces of network content uploaded by the terminal 101. Then, the server 102 trains the duration prediction model based on the plurality of pieces of network content and browsing duration of the plurality of pieces of network content.

In some embodiments, the server 102 is responsible for primary computing work, and the terminal 101 is responsible for secondary computing work. Alternatively, the server 102 is responsible for secondary computing work, and the terminal 101 is responsible for primary computing work. Alternatively, a distributed computing architecture may be employed between the server 102 and the terminal 101 for collaborative computing.

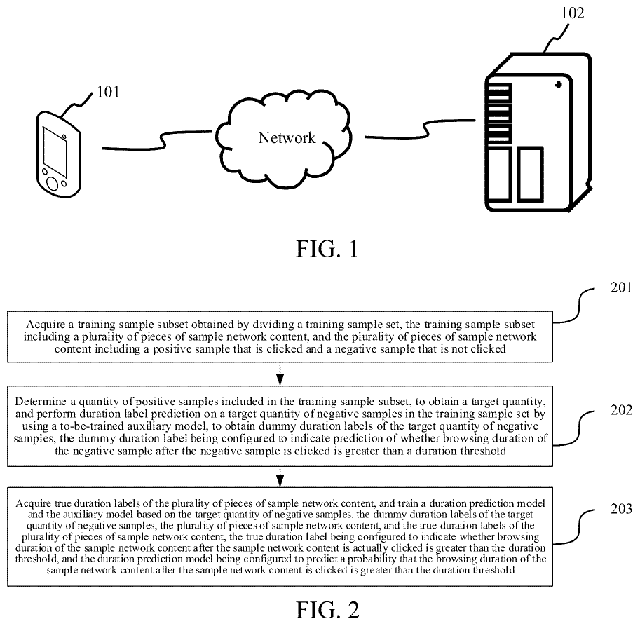

FIG. 2 is a flowchart of a duration prediction model training method according to an embodiment of this disclosure. As shown in FIG. 2, the embodiment of this disclosure is described by using an example in which the method is performed by a server. The duration prediction model training method includes the following operations.

201: Acquire a training sample subset obtained by dividing a training sample set, the training sample subset including a plurality of pieces of sample network content, and the plurality of pieces of sample network content including a positive sample that is clicked and a negative sample that is not clicked.

In some embodiments, the server acquires the training sample set, and divides the training sample set to obtain a plurality of training sample subsets. Each training sample subset includes a plurality of pieces of sample network content, and the plurality of pieces of sample network content includes a positive sample that is clicked and a negative sample that is not clicked. During division of the training sample set, the training sample set may be divided into the plurality of training sample subsets according to a preset quantity of sample network content in each training sample subset. Alternatively, the training sample set may be divided into a preset quantity of training sample subsets that need to be acquired.

In the embodiments of this disclosure, the training sample set includes the plurality of training sample subsets, and each training sample subset includes the plurality of pieces of sample network content. Each training sample subset is a batch for one iteration of training. The sample network content is content exposed to a sample user by using an application program installed on a terminal. The application program may be a social application program, an information application program, a shopping application program, or the like. A description is made by taking the social application program as an example, the sample network content may be a multimedia resource such as a picture, an article, or a video, which is not limited in the embodiments of this disclosure. The server can take network content uploaded by the terminal through the application program as the sample network content, or acquire the sample network content from a local database, or acquire the sample network content from another server, and construct the training sample set according to the acquired sample network content. The server can divide the plurality of pieces of sample network content into positive samples and negative samples according to click operations performed by the sample user on the sample network content. The positive sample is sample network content that is exposed to the sample user and that is clicked by the sample user; and the negative sample is sample network content that is exposed to the sample user and that is not clicked by the sample user.

202: Determine a quantity of positive samples included in the training sample subset, to obtain a target quantity, and perform duration label prediction on a target quantity of negative samples in the training sample set by using a to-be-trained auxiliary model, to obtain dummy duration labels of the target quantity of negative samples, the dummy duration label being configured to indicate prediction of whether browsing duration of the negative sample after the negative sample is clicked is greater than a duration threshold.

In some embodiments, the server counts the quantity of positive samples included in the training sample subset, to obtain the target quantity, and performs duration label prediction on the target quantity of negative samples in the training sample set by using the to-be-trained auxiliary model, to obtain the dummy duration labels of the target quantity of negative samples. The dummy duration label is configured to indicate prediction of whether the browsing duration of the negative sample after the negative sample is clicked is greater than the duration threshold.

In some embodiments, for any training sample subset, the server performs prediction on the target quantity of negative samples in the training sample set based on the auxiliary model, to obtain the dummy duration labels of the target quantity of negative samples. The auxiliary model is configured to generate the dummy duration labels for the negative samples. The target quantity is the same as the quantity of positive samples in the training sample subset. The dummy duration label is configured to indicate whether the browsing duration of the negative sample after the negative sample is clicked is greater than the duration threshold.

In the embodiments of this disclosure, the auxiliary model is a model obtained by pretraining based on a plurality of pieces of sample network content that is clicked and true duration labels of the plurality of pieces of sample network content. The true duration label is configured to indicate whether browsing duration of the sample network content after the sample network content is actually clicked is greater than the duration threshold. The server can predict, by using the auxiliary model, a probability that browsing duration of the sample network content in the training sample set after the sample network content is clicked is greater than the duration threshold. The training sample set includes a large quantity of negative samples that are not clicked. Because the negative samples are not clicked, browsing duration of the negative samples is recorded as 0, and further, duration labels of the negative samples are also recorded as 0. However, true browsing duration of the negative sample is unknown, and the duration label of the negative sample cannot be recorded as 0 just because the negative sample is not clicked. Therefore, for any training sample subset, the server can predict, by using the auxiliary model, probabilities that browsing duration of the target quantity of negative samples in the training sample set after the target quantity of negative samples are clicked is greater than the duration threshold, and determine the dummy duration labels of the target quantity of negative samples according to the obtained probabilities. The dummy duration label is configured to indicate whether the browsing duration of the negative sample after the negative sample is clicked is greater than the duration threshold. The target quantity is the same as the quantity of positive samples in the training sample subset.

203: Acquire true duration labels of the plurality of pieces of sample network content, and train a duration prediction model and the auxiliary model based on the target quantity of negative samples, the dummy duration labels of the target quantity of negative samples, the plurality of pieces of sample network content, and the true duration labels of the plurality of pieces of sample network content, the true duration label being configured to indicate whether browsing duration of the sample network content after the sample network content is actually clicked is greater than the duration threshold, and the duration prediction model being configured to predict a probability that the browsing duration of the sample network content after the sample network content is clicked is greater than the duration threshold.

In some embodiments, the server acquires the true duration labels of the plurality of pieces of sample network content, and trains the duration prediction model and the auxiliary model based on the target quantity of negative samples, the dummy duration labels of the target quantity of negative samples, the plurality of pieces of sample network content, and the true duration labels of the plurality of pieces of sample network content. The true duration label is configured to indicate whether browsing duration of the sample network content after the sample network content is actually clicked is greater than the duration threshold. The duration prediction model is configured to predict a probability that the browsing duration of the sample network content after the sample network content is clicked is greater than the duration threshold.

In some embodiments, a structure of the duration prediction model is identical to a structure of the auxiliary model. In this embodiment, the duration prediction model and the auxiliary model both have same layers and a same layer connection relationship. The duration prediction model and the auxiliary model may be obtained by training a same untrained initial model.

In some embodiments, the auxiliary model is trained based on the positive sample in the training sample subset, and the duration prediction model is trained based on the plurality of pieces of sample network content in the training sample subset and the target quantity of negative samples in the training sample subset.

Training data of the auxiliary model is the positive sample that is in the training sample subset and that is clicked, and training data of the duration prediction model is the plurality of pieces of sample network content in the training sample subset and the target quantity of negative samples that have a same quantity as the positive samples in the training sample subset. The server can synchronously train the duration prediction model and the auxiliary model based on the target quantity of negative samples, the dummy duration labels of the target quantity of negative samples, the plurality of pieces of sample network content in the training sample subset, and the true duration labels of the plurality of pieces of sample network content. In a training process, the server can respectively update model parameters of the duration prediction model and the auxiliary model based on a training loss obtained through training. The training loss is configured to reflect training precision of the auxiliary model and the duration prediction model. A smaller training loss indicates a more accurate dummy duration label generated by the auxiliary model for the negative sample, and a more accurate probability predicted by the duration prediction model that the browsing duration of the sample network content after the sample network content is clicked is greater than the duration threshold.

According to the duration prediction model training method provided in the embodiments of this disclosure, the auxiliary model is introduced to generate the dummy duration labels for the target quantity of negative samples in the training sample set, and then, the duration prediction model and the auxiliary model are trained based on the target quantity of negative samples, the dummy duration labels of the target quantity of negative samples, the plurality of pieces of sample network content in the training sample subset, and the true duration labels of the plurality of pieces of sample network content. In this way, the trained duration prediction model can further learn the negative sample according to the dummy duration label while learning the sample network content. The training data of the duration prediction model is increased, and training is performed based on both the positive sample and the negative sample, to solve the problem of sample selection deviation, whereby accuracy of duration prediction of the duration prediction model is improved.

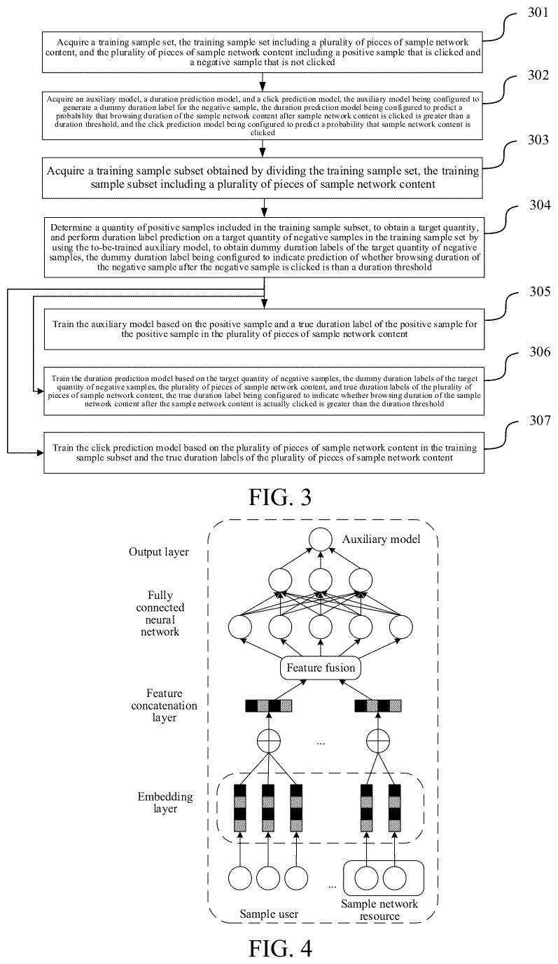

FIG. 3 is a flowchart of another duration prediction model training method according to an embodiment of this disclosure. As shown in FIG. 3, the embodiment of this disclosure is described by using an example in which the method is performed by a server. The duration prediction model training method includes the following operations.

301: Acquire a training sample set, the training sample set including a plurality of pieces of sample network content, and the plurality of pieces of sample network content including a positive sample that is clicked and a negative sample that is not clicked.

In the embodiments of this disclosure, the training sample set includes the plurality of pieces of sample network content. The sample network content is content exposed to a sample user by using an application program installed on a terminal. The application program may be a social application program, an information application program, a shopping application program, or the like. A description is made by taking the social application program as an example, the sample network content may be a multimedia resource such as a picture, an article, or a video, which is not limited in the embodiments of this disclosure. The server can take network content uploaded by the terminal through the application program as the sample network content, or acquire the sample network content from a local database, or acquire the sample network content from another server, and construct the training sample set according to the acquired sample network content. The server can divide the plurality of pieces of sample network content into positive samples and negative samples according to click operations performed by the sample user on the sample network content. The positive sample is sample network content that is exposed to the sample user and that is clicked by the sample user; and the negative sample is sample network content that is exposed to the sample user and that is not clicked by the sample user.

In some embodiments, the training sample set includes a plurality of feature fields that are configured to describe a plurality of attributes of the sample user and the sample network content. The plurality of feature fields includes a category sparse field and a numeric value continuous field. For example, an object identifier of the sample user, an interest category of the sample user, a network content identifier of the sample network content, and a published object identifier of the sample network content are all category sparse fields; and an exposure click-through rate of the sample user within a period of time and an exposure click-through rate of a published object of the sample network content within the period of time are numeric value continuous fields.

302: Acquire an auxiliary model, a duration prediction model, and a click prediction model, the auxiliary model being configured to generate a dummy duration label for the negative sample, the duration prediction model being configured to predict a probability that browsing duration of the sample network content after sample network content is clicked is greater than a duration threshold, and the click prediction model being configured to predict a probability that sample network content is clicked.

In the embodiments of this disclosure, model structures of the auxiliary model, the duration prediction model, and the click prediction model are identical. Training data of the auxiliary model is a plurality of positive samples that are in the training sample set and that are clicked, and training data of the duration prediction model and the click prediction model is all sample network content in the training sample set, including positive samples and negative samples. The server can synchronously train the auxiliary model, the duration prediction model, and the click prediction model based on the plurality of pieces of sample network content in the training sample set.

In addition, for ease of distinction, the auxiliary model, the duration prediction model, and the click prediction model may be respectively referred to as a first model, a second model, and a third model.

303: Acquire a training sample subset obtained by dividing the training sample set, the training sample subset including a plurality of pieces of sample network content.

In the embodiments of this disclosure, the server can perform a plurality of iterations of training on the auxiliary model, the duration prediction model, and the click prediction model. The server can divide the training sample set into a plurality of batches, namely, a plurality of training sample subsets. The plurality of pieces of sample network content in each training sample subset can be taken as a batch for one iteration of training of the auxiliary model, the duration prediction model, and the click prediction model.

304: Determine a quantity of positive samples included in the training sample subset, to obtain a target quantity, and perform duration label prediction on a target quantity of negative samples in the training sample set by using the to-be-trained auxiliary model, to obtain dummy duration labels of the target quantity of negative samples, the dummy duration label being configured to indicate prediction of whether browsing duration of the negative sample after the negative sample is clicked is than a duration threshold.

In some embodiments, for any training sample subset, the server performs prediction on the target quantity of negative samples in the training sample set based on the auxiliary model, to obtain the dummy duration labels of the target quantity of negative samples. The target quantity is the same as the quantity of positive samples in the training sample subset. The dummy duration label is configured to indicate whether the browsing duration of the negative sample after the negative sample is clicked is greater than the duration threshold.

In the embodiments of this disclosure, the training sample set includes a large quantity of negative samples that are not clicked. Because the negative samples are not clicked, browsing duration of the negative samples is recorded as 0, and further, duration labels of the negative samples are also recorded as 0. However, true browsing duration of the negative sample is unknown, and the duration label of the negative sample cannot be recorded as 0 just because the negative sample is not clicked. Therefore, for any training sample subset, the server can, for example randomly acquire, from the training sample set, the target quantity of negative samples that have a same quantity as the positive samples in the training sample subset. The server predicts, based on the auxiliary model, probabilities that browsing duration of the target quantity of negative samples after the target quantity of negative samples are clicked is greater than the duration threshold. The server determines the dummy duration labels of the target quantity of negative samples according to the predicted probabilities. The dummy duration label is configured to indicate whether the browsing duration of the negative sample after the negative sample is clicked is greater than the duration threshold. The target quantity is the same as the quantity of positive samples in the training sample subset. The duration threshold may be 65 seconds, 75 seconds, 85 seconds, or the like, which is not limited in the embodiment of this disclosure.

In some embodiments, the click prediction model is an untrained model. For any training sample subset, the server can synchronously train the auxiliary model, the duration prediction model, and the click prediction model based on the target quantity of negative samples, the dummy duration labels of the target quantity of negative samples, the plurality of pieces of sample network content, and true duration labels of the plurality of pieces of sample network content. The following respectively describes training processes of the auxiliary model, the duration prediction model, and the click prediction model. For the training process of the auxiliary model, refer to operation 305. For the training process of the duration prediction model, refer to operation 306. For the training process of the click prediction model, refer to operation 307.

305: Train the auxiliary model based on the positive sample and a true duration label of the positive sample for the positive sample in the plurality of pieces of sample network content.

In some embodiments, for any sample network content in the training sample subset, when the sample network content is a positive sample, the server trains the auxiliary model based on the positive sample and the true duration label of the positive sample. The true duration label is configured to indicate whether browsing duration of the positive sample after the positive sample is actually clicked is greater than the duration threshold.

In the embodiments of this disclosure, the auxiliary model is configured to generate the dummy duration label for the negative sample, that is, predict a probability that the browsing duration of the negative sample after the negative sample is clicked is greater than the duration threshold. After generating the dummy duration labels for the target quantity of negative samples based on the auxiliary model, the server can train the auxiliary model based on the plurality of positive samples in the training sample subset and the true duration labels of the plurality of positive samples. The server updates model parameters of the auxiliary model according to a training loss obtained through training, to improve accuracy of the dummy duration label generated by the auxiliary model for the negative sample. In this way, when performing prediction on a negative sample in a next batch of data, the auxiliary model can generate a more accurate dummy duration label.

In some embodiments, for the positive sample in the plurality of pieces of sample network content, the server determines a difference between a dummy duration label and the true duration label, and trains the auxiliary model based on the difference between the dummy duration label and the true duration label. Correspondingly, for any sample network content in the training sample subset, when the sample network content is a positive sample, the server performs prediction on the positive sample based on the auxiliary model, to obtain the dummy duration label of the positive sample; and trains the auxiliary model based on the difference between the dummy duration label and the true duration label. The dummy duration label is configured to indicate whether predicted browsing duration of the positive sample after the positive sample is clicked is greater than the duration threshold, and the true duration label is configured to indicate whether true browsing duration of the positive sample is greater than the duration threshold. The server can obtain the training loss of the auxiliary model based on the difference between the dummy duration label and the true duration label. The server can update the model parameters of the auxiliary model based on the training loss. The training loss is configured to reflect training precision of the auxiliary model. A smaller training loss indicates higher training precision, and a more accurate dummy duration label predicted by the auxiliary model for the sample network content.

For example, FIG. 4 is a schematic structural diagram of an auxiliary model according to an embodiment of this disclosure. Refer to FIG. 4. The auxiliary model includes a feature extraction layer (namely, an embedding layer), a feature concatenation layer, a fully connected neural network, and an output layer. The feature extraction layer is configured to perform feature extraction on input sample network content and sample user, to obtain a plurality of feature vectors that are configured to describe various attributes of the sample network content and the sample user in a high-dimensional space. The feature concatenation layer is configured to respectively concatenate the plurality of feature vectors of the sample user and the plurality of feature vectors of the sample network content, to obtain a concatenated feature vector of the sample user and a concatenated feature vector of the sample network content. Feature fusion is performed on the concatenated feature vector of the sample user and the concatenated feature vector of the sample network content, to obtain a fused feature vector. The fully connected neural network is configured to map the fused feature vector from the high-dimensional space to a low-dimensional space. The output layer is configured to output a probability predicted by the auxiliary model that browsing duration of the sample network content after the sample user clicks the sample network content is greater than the duration threshold.

306: Train the duration prediction model based on the target quantity of negative samples, the dummy duration labels of the target quantity of negative samples, the plurality of pieces of sample network content, and true duration labels of the plurality of pieces of sample network content, the true duration label being configured to indicate whether browsing duration of the sample network content after the sample network content is actually clicked is greater than the duration threshold.

In some embodiments, the operation of training the duration prediction model and the auxiliary model based on the target quantity of negative samples, the dummy duration labels of the target quantity of negative samples, the plurality of pieces of sample network content, and the true duration labels of the plurality of pieces of sample network content includes: for the positive sample in the plurality of pieces of sample network content, the auxiliary model and the duration prediction model are trained based on the positive sample and the true duration label of the positive sample; for the negative sample in the plurality of pieces of sample network content, the duration prediction model is trained based on the negative sample and the true duration label of the negative sample; and for the negative sample in the target quantity of negative samples, the duration prediction model is trained based on the negative sample and the dummy duration label of the negative sample.

In some embodiments, the operation of training the auxiliary model and the duration prediction model based on the positive sample and the true duration label of the positive sample for the positive sample in the plurality of pieces of sample network content includes: for the positive sample in the plurality of pieces of sample network content, duration label prediction is performed by using the auxiliary model, to obtain a dummy duration label of the positive sample; for the positive sample in the plurality of pieces of sample network content, duration label prediction is performed by using the duration prediction model, to obtain a predicted duration label of the positive sample, the predicted duration label being configured to indicate prediction of whether browsing duration of the positive sample after the positive sample is clicked is greater than the duration threshold; for the positive sample in the plurality of pieces of sample network content, a difference between the dummy duration label and the true duration label is determined, and the auxiliary model is trained based on the difference between the dummy duration label and the true duration label; and for the positive sample in the plurality of pieces of sample network content, a difference between the predicted duration label and the true duration label is determined, and the duration prediction model is trained based on the difference between the predicted duration label and the true duration label.

In some embodiments, the operation of performing duration label prediction by using the duration prediction model for the positive sample in the plurality of pieces of sample network content, to obtain the predicted duration label of the positive sample includes: for the positive sample in the plurality of pieces of sample network content, probability prediction is performed by using the duration prediction model, to obtain a duration prediction probability of the positive sample, the duration prediction probability being configured to indicate a probability that the browsing duration of the positive sample is greater than the duration threshold; for the positive sample in the plurality of pieces of sample network content, click-through rate prediction is performed on the positive sample by using a trained click prediction model, to obtain a click-through rate of the positive sample, the click-through rate being configured to indicate a probability that the positive sample is clicked, and the click prediction model being configured to predict a probability that sample network content is clicked; for the positive sample in the plurality of pieces of sample network content, a joint probability of the positive sample is determined according to the click-through rate of the positive sample and the duration prediction probability of the positive sample, the joint probability being configured to indicate a probability that the positive sample is clicked and the browsing duration of the positive sample is greater than the duration threshold; and the predicted duration label of the positive sample is determined according to the joint probability of the positive sample.

In some embodiments, the operation of training the duration prediction model based on the negative sample and the true duration label of the negative sample for the negative sample in the plurality of pieces of sample network content includes: for the native sample in the plurality of pieces of sample network content, duration label prediction is performed by using the duration prediction model, to obtain a predicted duration label of the negative sample, the predicted duration label indicating prediction of whether the browsing duration of the negative sample after the negative sample is clicked is greater than the duration threshold; and for the negative sample in the plurality of pieces of sample network content, a difference between the predicted duration label of the negative sample and the dummy duration label of the negative sample is determined, and the duration prediction model is trained based on the difference between the predicted duration label of the negative sample and the dummy duration label of the negative sample.

In some embodiments, the operation of performing duration label prediction by using the duration prediction model for the negative sample in the plurality of pieces of sample network content, to obtain the predicted duration label of the negative sample includes: for the negative sample in the plurality of pieces of sample network content, probability prediction is performed by using the duration prediction model, to obtain a duration prediction probability of the negative sample, the duration prediction probability being configured to indicate a probability that the browsing duration of the negative sample is greater than the duration threshold; for the negative sample in the plurality of pieces of sample network content, a click-through rate of the negative sample is predicted by using the trained click prediction model, the click-through rate being configured to indicate a probability that the negative sample is clicked, and the click prediction model being configured to predict a probability that sample network content is clicked; for the negative sample in the plurality of pieces of sample network content, a joint probability of the negative sample is determined according to the click-through rate of the negative sample and the duration prediction probability of the negative sample, the joint probability being configured to indicate a probability that the negative sample is clicked and the browsing duration of the negative sample is greater than the duration threshold; and the predicted duration label of the negative sample is determined according to the joint probability of the negative sample.

In some embodiments, the plurality of pieces of sample network content in the training sample subset includes the positive sample that is clicked and the positive sample that is not clicked. For the positive sample that is clicked, the true duration label of the positive sample may be 0 or 1. 0 represents that true browsing duration of the positive sample is not greater than the duration threshold, indicating relatively short browsing duration of the positive sample. 1 represents that true browsing duration of the positive sample is greater than the duration threshold, indicating relatively long browsing duration of the positive sample. For the negative sample that is not clicked, because the negative sample is not clicked, the true duration label of the negative sample is 0. To reduce impact of a large quantity of negative samples with true duration labels of 0 in the training sample subset on the prediction performance of the duration prediction model, the server can perform one iteration of training on the duration prediction model based on the target quantity of negative samples that are acquired from the training sample set and the dummy duration labels of the target quantity of negative samples together with the plurality of pieces of sample network content in the training sample subset and the true duration labels of the plurality of pieces of sample network content. The negative sample with the dummy duration label is sampled for training of the duration prediction model, whereby the duration prediction model can further learn the negative sample based on a magnitude relationship between the browsing duration of the negative sample after the negative sample is clicked and the duration threshold that is indicated by the dummy duration label, to improve accuracy of duration prediction of the duration prediction model.

In some embodiments, the server trains the duration prediction model based on differences between predicted duration labels and the true duration labels of the plurality of pieces of sample network content in the training sample subset and the differences between the predicted duration labels and the dummy duration labels of the target quantity of negative samples. Correspondingly, the following respectively describes processes in which the server trains the duration prediction model based on the plurality of pieces of sample network content and the target quantity of negative samples. For the process in which the server trains the duration prediction model based on the plurality of pieces of sample network content in the training sample subset, refer to operation (1). For the process in which the server trains the duration prediction model based on the target quantity of negative samples, refer to operation (2).

(1) For any sample network content in the training sample subset, the server performs prediction on the sample network content based on the duration prediction model, to obtain the predicted duration label of the sample network content, the predicted duration label being configured to indicate prediction of whether the browsing duration of the sample network content after the sample network content is clicked is greater than the duration threshold; and trains the duration prediction model based on the difference between the predicted duration label and the true duration label.

In the embodiments of this disclosure, the predicted duration label is configured to indicate prediction of whether predicted browsing duration of the sample network content after the sample network content is clicked is greater than the duration threshold. The true duration label is configured to indicate whether true browsing duration of the sample network content after the sample network content is actually clicked is greater than the duration threshold. The server can obtain a training loss of the duration prediction model based on the difference between the predicted duration label and the true duration label. The server can update model parameters of the duration prediction model based on the training loss. The training loss is configured to reflect training precision of the duration prediction model. A smaller training loss indicates higher training precision, and a more accurate predicted duration label predicted by the duration prediction model for the sample network content. In this way, accuracy of duration prediction of the duration prediction model is improved.

In some embodiments, the server determines the predicted duration label of the sample network content according to a joint probability of the sample network content. Correspondingly, the server performs prediction on the sample network content based on the duration prediction model, to obtain a duration prediction probability of the sample network content, the duration prediction probability being configured to indicate a probability that the browsing duration of the sample network content is greater than the duration threshold; performs prediction on the sample network content based on the click prediction model, to obtain a click-through rate of the sample network content, the click-through rate being configured to indicate a probability that the sample network content is clicked; determines the joint probability of the sample network content according to the click-through rate of the sample network content and the duration prediction probability of the sample network content, the joint probability being configured to indicate a probability that the sample network content is clicked and the browsing duration of the sample network content is greater than the duration threshold; and determines the predicted duration label of the sample network content according to the joint probability of the sample network content. The server trains the duration prediction model based on all sample network content in the training sample subset. For any sample network content in the training sample subset, the duration prediction model can output a duration prediction probability of the sample network content. The duration prediction probability is taken as a conditional probability, and a precondition for occurrence of the conditional probability is that the sample network content is clicked. However, the training sample subset includes both the positive sample that is clicked and the negative sample that is not clicked. Therefore, the server can determine the predicted duration label of the sample network content according to a product of the click-through rate of the sample network content that is outputted by the click prediction model and the duration prediction probability of the sample network content that is outputted by the duration prediction model, namely, the joint probability of the sample network content. Then, the duration prediction model is trained based on the difference between the predicted duration label and the true duration label. The predicted duration label is determined according to the joint probability, whereby the duration prediction probability of the sample network content can be indirectly learned based on a relationship among the click-through rate, the duration prediction probability, and the joint probability. A task of predicting a click-through rate and a joint probability of sample network content is implemented based on a full sample space, whereby the problem of sample selection deviation is avoided, and accuracy of the duration prediction model is improved.

In some embodiments, the server calculates the joint probability of the sample network content by using the following formula 1.

$$P ( time > 85 , click = 1 \vert D 1 ) = P ( time > 85 \vert click = 1 , D 1 ) \times P ( click = 1 \vert D 1 ) \qquad Formula 1$$

where, D1 represents the training sample subset; P(click=1|D1) represents the probability that the sample network content in the training sample subset is clicked; P(time>85|click=1, D1) represents a probability that browsing duration of the sample network content in the training sample subset after the sample network content is clicked is greater than 85 seconds; and P(time>85, click=1|D1) represents a probability that the sample network content in the training sample subset is clicked and the browsing duration of the sample network content is greater than 85 seconds.

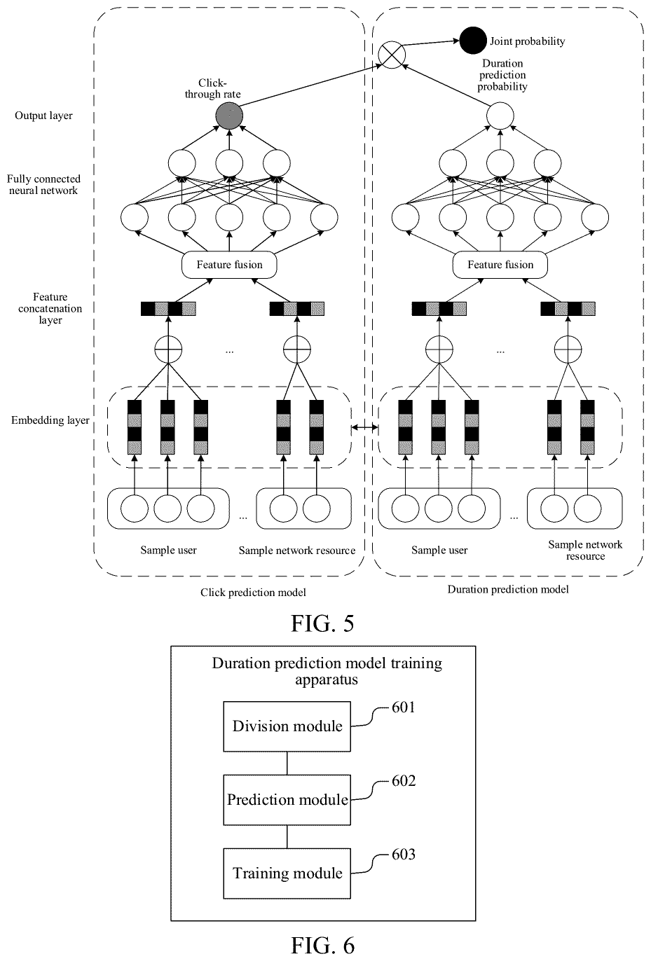

For example, FIG. 5 is a schematic structural diagram of a duration prediction model and a click prediction model according to an embodiment of this disclosure. As shown in FIG. 5, the click prediction model is shown on the left, and the duration prediction model is shown on the right. Model structures of the click prediction model and the duration prediction model are identical. A description is made by taking the click prediction model as an example, the click prediction model includes a feature extraction layer (namely, an embedding layer), a feature concatenation layer, a fully connected neural network, and an output layer. The feature extraction layer is configured to perform feature extraction on input sample network content and sample user, to obtain a plurality of feature vectors that are configured to describe various attributes of the sample network content and the sample user in a high-dimensional space. The feature concatenation layer is configured to respectively concatenate the plurality of feature vectors of the sample user and the plurality of feature vectors of the sample network content, to obtain a concatenated feature vector of the sample user and a concatenated feature vector of the sample network content. Feature fusion is performed on the concatenated feature vector of the sample user and the concatenated feature vector of the sample network content, to obtain a fused feature vector. The fully connected neural network is configured to map the fused feature vector from the high-dimensional space to a low-dimensional space. The output layer is configured to output a probability predicted by the click prediction model that the sample user clicks the sample network content. An output of the click prediction model is a click-through rate of the sample network content, and an output of the duration prediction model is a duration prediction probability of the sample network content. A joint probability of the sample network content can be obtained by calculating a product of the click-through rate and the duration prediction probability.

(2) For any negative sample in the target quantity of negative samples, the server performs prediction on the negative sample based on the duration prediction model, to obtain the predicted duration label of the negative sample, the predicted duration label indicating whether the browsing duration of the negative sample after the negative sample is clicked is greater than the duration threshold; and trains the duration prediction model based on the difference between the predicted duration label and the dummy duration label.

In the embodiments of this disclosure, the server performs prediction on the negative sample based on the auxiliary model, to obtain the dummy duration label of the negative sample, and takes the dummy duration label as a true duration label of the negative sample. The predicted duration label is configured to indicate prediction of whether the browsing duration of the negative sample after the negative sample is clicked is greater than the duration threshold, and the dummy duration label is configured to indicate whether true browsing duration of the negative sample after the negative sample is clicked is greater than the duration threshold. The server can obtain a training loss of the duration prediction model based on the difference between the predicted duration label and the dummy duration label. The server can update model parameters of the duration prediction model based on the training loss. The training loss is configured to reflect training precision of the duration prediction model. A smaller training loss indicates higher training precision, and a more accurate predicted duration label predicted by the duration prediction model for the negative sample. In this way, accuracy of duration prediction of the duration prediction model is improved.

In some embodiments, the server determines the predicted duration label of the negative sample with the dummy duration label according to the joint probability of the sample network content. Correspondingly, for any negative sample, the server performs prediction on the negative sample based on the duration prediction model, to obtain a duration prediction probability of the negative sample, the duration prediction probability being configured to indicate a probability that browsing duration of the negative sample is greater than the duration threshold; performs prediction on the negative sample based on the click prediction model, to obtain a click-through rate of the negative sample, the click-through rate being configured to indicate a probability that the negative sample is clicked; determines a joint probability of the negative sample according to the click-through rate of the negative sample and the duration prediction probability of the negative sample, the joint probability being configured to indicate a probability that the negative sample is clicked and the browsing duration of the negative sample is greater than the duration threshold; and determines a predicted duration label of the negative sample according to the joint probability of the negative sample. For any negative sample in the target quantity of negative samples, the duration prediction model can output a duration prediction probability of the negative sample. The duration prediction probability is taken as a conditional probability, and a precondition for occurrence of the conditional probability is that the negative sample is clicked. However, the negative sample is sample network content that is not clicked. Therefore, the server can determine the predicted duration label of the negative sample according to a product of the click-through rate of the negative sample that is outputted by the click prediction model and the duration prediction probability of the negative sample that is outputted by the duration prediction model, namely, the joint probability of the negative sample. Then, the duration prediction model is trained based on the difference between the predicted duration label and the dummy duration label. The predicted duration label is determined according to the joint probability, whereby the duration prediction probability of the negative sample can be indirectly learned based on a relationship among the click-through rate, the duration prediction probability, and the joint probability. A task of predicting a click-through rate and a joint probability of a negative sample is implemented based on a full sample space, whereby the problem of sample selection deviation is avoided, and accuracy of the duration prediction model is improved. The predicted duration label of the negative sample is determined according to the joint probability of the negative sample. Specifically, when the joint probability of the negative sample is greater than a preset probability threshold, a predicted duration label representing that the browsing duration of the negative sample after the negative sample is clicked is predicted to be greater than the duration threshold may be assigned to the negative sample, for example, a predicted duration label with a value of 1 is assigned; and when the joint probability of the negative sample is not greater than the preset probability threshold, a predicted duration label representing that the browsing duration of the negative sample after the negative sample is clicked is predicted to be not greater than the duration threshold may be assigned to the negative sample, for example, a predicted duration label with a value of 0 is assigned.

307: Train the click prediction model based on the plurality of pieces of sample network content in the training sample subset and the true duration labels of the plurality of pieces of sample network content.

In the embodiments of this disclosure, the click prediction model is configured to predict a click-through rate of sample network content, that is, predict a probability that the sample network content is clicked. The server can train the click prediction model based on the plurality of pieces of sample network content in the training sample subset and the true duration labels of the plurality of pieces of sample network content. The server updates model parameters of the click prediction model according to a training loss obtained through training, whereby accuracy of the click-through rate predicted by the click prediction model for the sample network content can be improved.

In some embodiments, the duration prediction model training method further includes: for any sample network content (e.g., a new piece of sample network content), a click-through rate of the sample network content is predicted by using the click prediction model; a value representing that browsing duration of the sample network content is less than the duration threshold is assigned to the true duration label of the sample network content in a case that the click-through rate of the sample network content is less than a click threshold and the sample network content is a negative sample; the target quantity of negative samples are, for example randomly acquired from a plurality of pieces of assigned sample network content of the training sample subset; and the target quantity of acquired negative samples are added to the training sample set.

In some embodiments, the server can select some negative samples from the training sample subset as negative samples whose true duration labels are 0, and place the negative samples into the training sample set. Correspondingly, for any sample network content, the server performs prediction on the sample network content based on the click prediction model, to obtain a click-through rate of the sample network content; determines the sample network content as a simple negative sample if the click-through rate of the sample network content is less than the click threshold and the sample network content is a negative sample, a true duration label of the simple negative sample being 0; acquires (e.g., randomly) the target quantity of simple negative samples from a plurality of simple negative samples in the training sample subset; and places the target quantity of simple negative samples into the training sample set. The case where the click-through rate of the sample network content is less than the click threshold and the sample network content is a negative sample indicates a low probability that the unclicked negative sample is clicked. The click prediction model can infer that a sample user shows relatively low interest in the negative sample according to the click-through rate. Therefore, the server can determine the negative sample as the simple negative sample. The true duration label of the simple negative sample is 0, that is, it is considered that a probability that true browsing duration of the negative sample after the negative sample is clicked is greater than the duration threshold is close to 0. For the plurality of simple negative samples in the training sample subset, the server can acquire the target quantity of simple negative samples that have a same quantity as the positive samples in the training sample subset, and place the target quantity of simple negative samples into the training sample set as the training data of the duration prediction model. The negative sample with a relatively low click-through rate is added to the training sample set, whereby the training data of the duration prediction model can be continuously increased, training difficulty of performing joint training on the duration prediction model and the click prediction model is reduced, and correlation between the click prediction model and the duration prediction model is enhanced.

In some embodiments, the click prediction model is a trained model. During training of the duration prediction model, the server can directly acquire the click prediction model, and predict a click-through rate of sample network content based on the click prediction model.

According to the duration prediction model training method provided in the embodiments of this disclosure, the auxiliary model is introduced to generate the dummy duration labels for the target quantity of negative samples in the training sample set, and then, the duration prediction model and the auxiliary model are trained based on the target quantity of negative samples, the dummy duration labels of the target quantity of negative samples, the plurality of pieces of sample network content in the training sample subset, and the true duration labels of the plurality of pieces of sample network content. In this way, the trained duration prediction model can further learn the negative sample according to the dummy duration label while learning the sample network content. The training data of the duration prediction model is increased, and training is performed based on both the positive sample and the negative sample, to solve the problem of sample selection deviation, whereby accuracy of duration prediction of the duration prediction model is improved.

FIG. 6 is a block diagram of a duration prediction model training apparatus according to an embodiment of this disclosure. The apparatus is configured to perform the foregoing duration prediction model training method. Refer to FIG. 6. The apparatus includes: a division module 601, a prediction module 602, and a training module 603.

The division module 601 is configured to acquire a training sample subset obtained by dividing a training sample set, the training sample subset including a plurality of pieces of sample network content, and the plurality of pieces of sample network content including a positive sample that is clicked and a negative sample that is not clicked.

The prediction module 602 is configured to determine a quantity of positive samples included in the training sample subset, to obtain a target quantity, and perform duration label prediction on a target quantity of negative samples in the training sample set by using a to-be-trained auxiliary model, to obtain dummy duration labels of the target quantity of negative samples, the dummy duration label being configured to indicate prediction of whether browsing duration of the negative sample after the negative sample is clicked is greater than a duration threshold.

The training module 603 is configured to acquire true duration labels of the plurality of pieces of sample network content, and train a duration prediction model and the auxiliary model based on the target quantity of negative samples, the dummy duration labels of the target quantity of negative samples, the plurality of pieces of sample network content, and the true duration labels of the plurality of pieces of sample network content, the true duration label being configured to indicate whether browsing duration of the sample network content after the sample network content is actually clicked is greater than the duration threshold, and the duration prediction model being configured to predict a probability that the browsing duration of the sample network content after the sample network content is clicked is greater than the duration threshold.

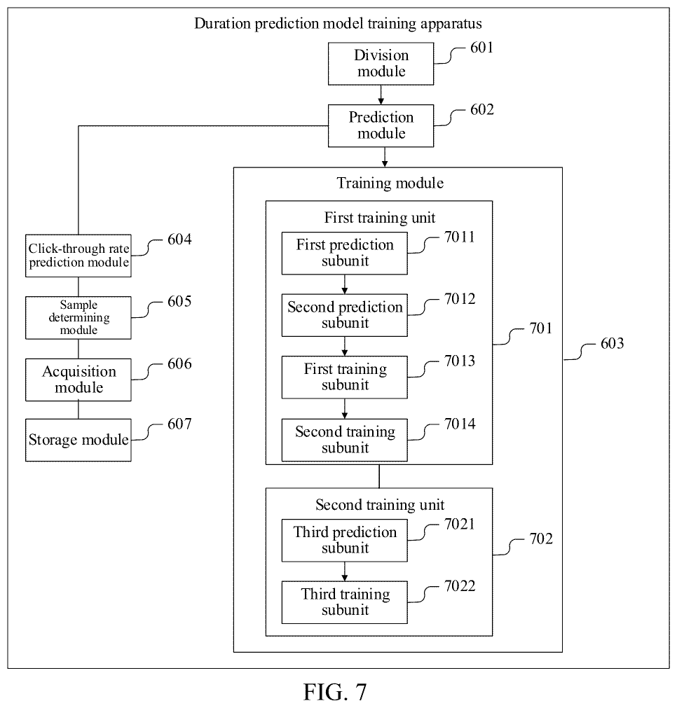

In some embodiments, FIG. 7 is a block diagram of another duration prediction model training apparatus according to an embodiment of this disclosure. Refer to FIG. 7. A training module 603 apparatus includes:
a first training unit 701, configured to train an auxiliary model and a duration prediction model based on a positive sample and a true duration label of the positive sample for the positive sample in a plurality of pieces of sample network content; and
train the duration prediction model based on a negative sample and a true duration label of the negative sample for the negative sample in the plurality of pieces of sample network content; and
a second training unit 702, configured to train the duration prediction model based on a negative sample and a dummy duration label of the negative sample for the negative sample in a target quantity of negative samples.

Refer to FIG. 7. In some embodiments, the first training unit 701 includes:
a first prediction subunit 7011, configured to perform duration label prediction by using the auxiliary model for the positive sample in the plurality of pieces of sample network content, to obtain a dummy duration label of the positive sample;
a second prediction subunit 7012, configured to perform duration label prediction by using the duration prediction model for the positive sample in the plurality of pieces of sample network content, to obtain a predicted duration label of the positive sample, the predicted duration label being configured to indicate prediction of whether browsing duration of the positive sample after the positive sample is clicked is greater than a duration threshold;
a first training subunit 7013, configured to determine a difference between the dummy duration label and the true duration label for the positive sample in the plurality of pieces of sample network content, and train the auxiliary model based on the difference between the dummy duration label and the true duration label; and
a second training subunit 7014, configured to determine a difference between the predicted duration label and the true duration label for the positive sample in the plurality of pieces of sample network content, and train the duration prediction model based on the difference between the predicted duration label and the true duration label.

In some embodiments, the second prediction subunit 7012 is configured to perform probability prediction by using the duration prediction model for the positive sample in the plurality of pieces of sample network content, to obtain a duration prediction probability of the positive sample, the duration prediction probability being configured to indicate a probability that the browsing duration of the positive sample is greater than the duration threshold; perform click-through rate prediction on the positive sample by using a trained click prediction model for the positive sample in the plurality of pieces of sample network content, to obtain a click-through rate of the positive sample, the click-through rate being configured to indicate a probability that the positive sample is clicked, and the click prediction model being configured to predict a probability that sample network content is clicked; determine a joint probability of the positive sample according to the click-through rate of the positive sample and the duration prediction probability of the positive sample for the positive sample in the plurality of pieces of sample network content, the joint probability being configured to indicate a probability that the positive sample is clicked and the browsing duration of the positive sample is greater than the duration threshold; and determine the predicted duration label of the positive sample according to the joint probability of the positive sample.

Refer to FIG. 7. In some embodiments, the second training unit 702 includes:
a third prediction subunit 7021, configured to perform duration label prediction by using the duration prediction model for the negative sample in the plurality of pieces of sample network content, to obtain a predicted duration label of the negative sample, the predicted duration label indicating prediction of whether browsing duration of the negative sample after the negative sample is clicked is greater than the duration threshold; and
a third training subunit 7022, configured to determine a difference between the predicted duration label of the negative sample and the dummy duration label of the negative sample for the negative sample in the plurality of pieces of sample network content, and train the duration prediction model based on the difference between the predicted duration label of the negative sample and the dummy duration label of the negative sample.

In some embodiments, the third prediction subunit 7021 is configured to perform probability prediction by using the duration prediction model for the negative sample in the plurality of pieces of sample network content, to obtain a duration prediction probability of the negative sample, the duration prediction probability being configured to indicate a probability that the browsing duration of the negative sample is greater than the duration threshold; predict a click-through rate of the negative sample by using the trained click prediction model for the negative sample in the plurality of pieces of sample network content, the click-through rate being configured to indicate a probability that the negative sample is clicked, and the click prediction model being configured to predict a probability that sample network content is clicked; determine a joint probability of the negative sample according to the click-through rate of the negative sample and the duration prediction probability of the negative sample for the negative sample in the plurality of pieces of sample network content, the joint probability being configured to indicate a probability that the negative sample is clicked and the browsing duration of the negative sample is greater than the duration threshold; and determine the predicted duration label of the negative sample according to the joint probability of the negative sample.

Refer to FIG. 7. In some embodiments, the apparatus further includes:
a click-through rate prediction module 604, configured to predict a click-through rate of sample network content by using the click prediction model for any sample network content;
a sample determining module 605, configured to assign a value representing that browsing duration of the sample network content is less than the duration threshold to a true duration label of the sample network content in a case that the click-through rate of the sample network content is less than a click threshold and the sample network content is a negative sample;
an acquisition module 606, configured to, for example randomly, acquire the target quantity of negative samples from a plurality of pieces of assigned sample network content of a training sample subset; and
a storage module 607, configured to add the target quantity of acquired negative samples to a training sample set.

In some embodiments, the training module 603 is further configured to train the click prediction model based on the plurality of pieces of sample network content and true duration labels of the plurality of pieces of sample network content.

According to the duration prediction model training apparatus provided in the embodiments of this disclosure, the auxiliary model is introduced to generate the dummy duration labels for the target quantity of negative samples in the training sample set, and then, the duration prediction model and the auxiliary model are trained based on the target quantity of negative samples, the dummy duration labels of the target quantity of negative samples, the plurality of pieces of sample network content in the training sample subset, and the true duration labels of the plurality of pieces of sample network content. In this way, the trained duration prediction model can further learn the negative sample according to the dummy duration label while learning the sample network content. The training data of the duration prediction model is increased, and training is performed based on both the positive sample and the negative sample, to solve the problem of sample selection deviation, whereby accuracy of duration prediction of the duration prediction model is improved.

In addition, the duration prediction model training apparatus provided in the foregoing embodiments is illustrated only with an example of division of the foregoing functional modules. In practical applications, the foregoing functions may be allocated to and completed by different functional modules according to requirements. That is, an internal structure of a terminal is divided into different functional modules to complete all or some of the functions described above. In addition, the duration prediction model training apparatus provided in the foregoing embodiments and the embodiments of the duration prediction model training method belong to the same concept. For details of a specific implementation process of the apparatus, refer to the method embodiments. Details are not described herein again.

In the embodiments of this disclosure, a computer device is configured as a terminal or a server. When the computer device is configured as a server, the server may be taken as an execution body to implement the technical solutions provided in the embodiments of this disclosure. When the computer device is configured as a terminal, the terminal may be taken as an execution body to implement the technical solutions provided in the embodiments of this disclosure. This is not limited in the embodiments of this disclosure.

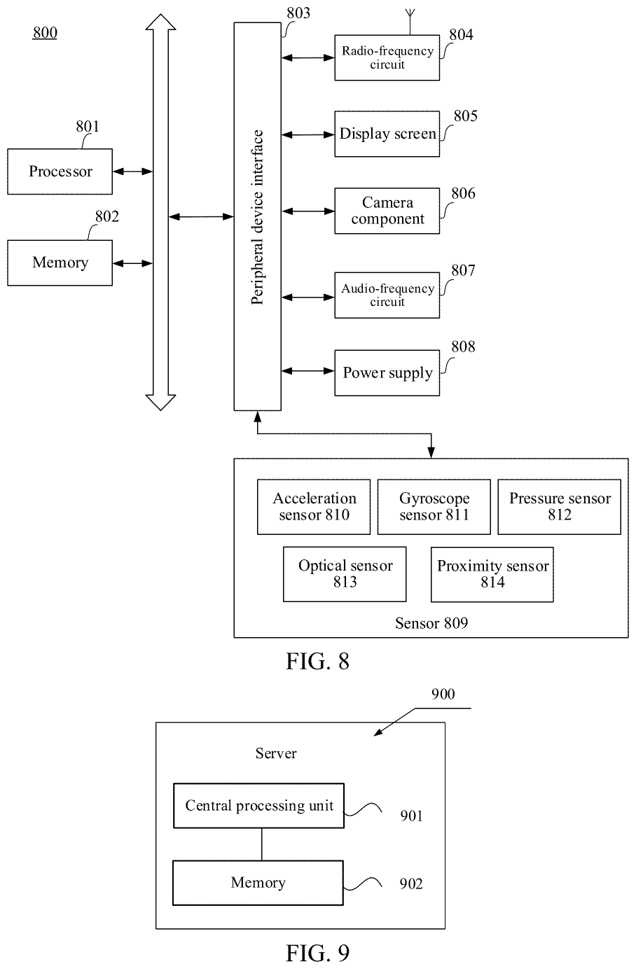

FIG. 8 is a structural block diagram of a terminal 800 according to an embodiment of this disclosure. The terminal 800 may be a portable mobile terminal, such as a smartphone, a tablet computer, a Moving Picture Experts Group Audio Layer III (MP3) player, a Moving Picture Experts Group Audio Layer IV (MP4) player, a notebook computer, or a desktop computer. The terminal 800 may also be referred to as another name such as a user device, a portable terminal, a laptop terminal, or a desktop terminal.

Generally, the terminal 800 includes: a processor 801 and a memory 802.

The processor 801 may include one or more processing cores, for example, a 4-core processor or an 8-core processor. The processor 801 may be implemented in at least one hardware form of a digital signal processor (DSP), a field-programmable gate array (FPGA), and a programmable logic array (PLA). Alternatively, the processor 801 may include a main processor and a coprocessor. The main processor is a processor configured to process data in an active state, which is also referred to as a central processing unit (CPU). The coprocessor is a low-power-consumption processor configured to process data in a standby state. In some embodiments, the processor 801 is integrated with a graphics processing unit (GPU). The GPU is configured to render and draw content that needs to be displayed on a display screen. In some embodiments, the processor 801 further includes an AI processor. The AI processor is configured to process computing operations related to ML.

The memory 802 may include one or more computer-readable storage media. The computer-readable storage medium may be non-transient. The memory 802 may further include a high-speed random-access memory (RAM) and a non-volatile memory, for example, one or more disk storage devices or flash storage devices. In some embodiments, the non-transient computer-readable storage medium in the memory 802 is configured to store at least one computer program. The processor 801 executes the at least one computer program to implement the duration prediction model training method provided in the method embodiments of this disclosure.

In some embodiments, the terminal 800 further includes: a peripheral device interface 803 and at least one peripheral device. The processor 801, the memory 802, and the peripheral device interface 803 may be connected via a bus or a signal cable. Each peripheral device may be connected to the peripheral device interface 803 via the bus, the signal cable, or a circuit board. Specifically, the peripheral device includes: at least one of a radio-frequency (RF) circuit 804, a display screen 805, a camera component 806, an audio-frequency circuit 807, and a power supply 808.

The peripheral device interface 803 may be configured to connect the at least one peripheral device related to input/output (I/O) to the processor 801 and the memory 802. In some embodiments, the processor 801, the memory 802, and the peripheral device interface 803 are integrated on a same chip or circuit board. In some other embodiments, any one or two of the processor 801, the memory 802, and the peripheral device interface 803 are implemented on independent chips or circuit boards, which is not limited in this embodiment.

The RF circuit 804 is configured to receive and transmit an RF signal, which is also referred to as an electromagnetic signal. The RF circuit 804 communicates with a communication network and another communication device through the electromagnetic signal. The RF circuit 804 converts an electrical signal into an electromagnetic signal for transmission, or converts a received electromagnetic signal into an electrical signal. In some embodiments, the RF circuit 804 includes: an antenna system, an RF transceiver, one or more amplifiers, a tuner, an oscillator, a DSP, a codec chipset, a user identity module card, and the like. The RF circuit 804 may communicate with another terminal by using at least one wireless communications protocol. The wireless communications protocol includes, but is not limited to, the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF circuit 804 further includes a circuit related to near field communication (NFC), which is not limited in this disclosure.

The display screen 805 is configured to display a user interface (UI). The UI may include a graph, text, an icon, a video, and any combination thereof. When the display screen 805 is a touch display screen, the display screen 805 further has a capability of collecting a touch signal on or above a surface of the display screen 805. The touch signal may be inputted as a control signal to the processor 801 for processing. In this case, the display screen 805 may be further configured to provide a virtual button and/or a virtual keyboard, which is also referred to as a soft button and/or a soft keyboard. In some embodiments, one display screen 805 is arranged on a front panel of the terminal 800. In some other embodiments, at least two display screens 805 are respectively arranged on different surfaces of the terminal 800 or in a folded design. In some other embodiments, the display screen 805 is a flexible display screen arranged on a curved surface or a folded surface of the terminal 800. Even, the display screen 805 may further be arranged in a non-rectangular irregular pattern, namely, a special-shaped screen. The display screen 805 may be prepared from a material such as a liquid crystal display (LCD), an organic light-emitting diode (OLED), or the like.

The camera component 806 is configured to capture images or videos. In some embodiments, the camera component 806 includes a front camera and a rear camera. Generally, the front camera is arranged on the front panel of the terminal, and the rear camera is arranged on a back surface of the terminal. In some embodiments, at least two rear cameras are arranged, which are respectively any one of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 806 further includes a flash. The flash may be a monochrome temperature flash or a double color temperature flash. The double color temperature flash refers to a combination of a warm light flash and a cold light flash, and is configured to compensate for light under different color temperatures.

The audio-frequency circuit 807 may include a microphone and a speaker. The microphone is configured to collect sound waves of a user and an environment, and convert the sound waves into an electrical signal and input the electrical signal into the processor 801 for processing, or input the electrical signal into the RF circuit 804 for implementing voice communication. For the purpose of stereo collection or noise reduction, a plurality of microphones may be respectively arranged at different portions of the terminal 800. The microphone may be an array microphone or an omni-directional collection type microphone. The speaker is configured to convert an electric signal from the processor 801 or the RF circuit 804 into sound waves. The speaker may be a conventional film speaker or a piezoelectric ceramic speaker. When the speaker is a piezoelectric ceramic speaker, the speaker can not only convert an electric signal into sound waves audible to a human being, but also convert an electric signal into sound waves inaudible to a human being, for ranging and other purposes. In some embodiments, the audio-frequency circuit 807 further includes an earphone jack.

The power supply 808 is configured to supply power to the components in the terminal 800. The power supply 808 may be an alternating current, a direct current, a primary battery, or a rechargeable battery. When the power supply 808 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may further be configured to support a fast charging technology.

In some embodiments, the terminal 800 further includes one or more sensors 809. The one or more sensors 809 include, but are not limited to, an acceleration sensor 810, a gyroscope sensor 811, a pressure sensor 812, an optical sensor 813, and a proximity sensor 814.

The acceleration sensor 810 may detect a magnitude of acceleration on three coordinate axes of a coordinate system established with the terminal 800. For example, the acceleration sensor 810 is configured to detect components of gravity acceleration on the three coordinate axes. The processor 801 may control, according to a gravity acceleration signal collected by the acceleration sensor 810, the touch display screen 805 to display the UI in a landscape view or a portrait view. The acceleration sensor 810 may further be configured to collect motion data of a game or a user.

The gyroscope sensor 811 may detect a body direction and a rotation angle of the terminal 800. The gyroscope sensor 811 may cooperate with the acceleration sensor 810 to collection a three-dimensional (3D) action of the user on the terminal 800. The processor 801 may implement the following functions according to data collected by the gyroscope sensor 811: motion sensing (such as changing the UI according to a tilt operation of the user), image stabilization at shooting, game control, and inertial navigation.

The pressure sensor 812 may be arranged on a side frame of the terminal 800 and/or a layer below the display screen 805. When arranged on the side frame of the terminal 800, the pressure sensor 812 may detect a holding signal of the user on the terminal 800. The processor 801 performs left or right hand recognition or a quick operation according to the holding signal collected by the pressure sensor 812. When the pressure sensor 812 is arranged on the layer below the touch display screen 805, the processor 801 controls, according to a pressure operation of the user on the display screen 805, an operable control on the UI. The operable control includes at least one of a button control, a scroll-bar control, an icon control, and a menu control.

The optical sensor 813 is configured to collect an ambient light intensity. In an embodiment, the processor 801 controls the display brightness of the display screen 805 according to the ambient light intensity collected by the optical sensor 813. Specifically, when the ambient light intensity is relatively high, the display brightness of the display screen 805 is increased; and when the ambient light intensity is relatively low, the display brightness of the display screen 805 is decreased. In another embodiment, the processor 801 further dynamically adjust camera parameters of the camera component 806 according to the ambient light intensity collected by the optical sensor 813.

The proximity sensor 814, also referred to as a distance sensor, is generally arranged on the front panel of the terminal 800. The proximity sensor 814 is configured to collect a distance between the user and a front surface of the terminal 800. In an embodiment, when the proximity sensor 814 detects that the distance between the user and the front surface of the terminal 800 gradually decreases, the processor 801 controls the display screen 805 to switch from a screen-on state to a screen-off state; and when the proximity sensor 804 detects that the distance between the user and the front surface of the terminal 800 gradually increases, the processor 801 controls the display screen 805 to switch from the screen-off state to the screen-on state.

Those skilled in the art may understand that the structure shown in FIG. 8 does not constitute a limitation to the terminal 800, and the terminal may include more or fewer components than those shown in the figure, or some components may be combined, or a different component deployment may be employed.

FIG. 9 is a schematic structural diagram of a server according to an embodiment of this disclosure. A server 900 may vary considerably depending on configuration or performance, and may include one or more CPUs 901 and one or more memories 902. Each memory 902 has at least one computer program stored therein. Each CPU 901 loads and executes the at least one computer program to implement the duration prediction model training method provided in the foregoing method embodiments. It is clear that the server may further include components such as a wired or wireless network interface, a keyboard, and an I/O interface, to perform I/O. The server may further include another component configured to implement a device function. Details are not described herein.

The embodiments of this disclosure further provide a computer-readable storage medium, which has at least one computer program stored therein. A processor loads and executes the at least one computer program to implement the duration prediction model training method according to the foregoing embodiments. For example, the computer-readable storage medium is a read-only memory (ROM), an RAM, a compact disc ROM (CD-ROM), a magnetic tape, a floppy disk, an optical data storage device, or the like.

The embodiments of this disclosure further provide a computer program product, which includes a computer program. A processor executes the computer program to implement the duration prediction model training method according to the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in different manners to form other embodiments. To make description concise, not all possible combinations of the technical features in the foregoing embodiments are described. However, the combinations of these technical features are considered as falling within the scope recorded by this description provided that no conflict exists.

The foregoing embodiments only describe several examples of implementations of this disclosure, which are not to be construed as a limitation to the patent scope of this disclosure. For those of ordinary skill in the art, several transformations and improvements may further be made without departing from the concept of this disclosure. These transformations and improvements belong to the scope of this disclosure.

What is claimed is:

1. A method of duration prediction model training, the method comprising:
acquiring at least a training sample subset from a training sample set, the training sample subset comprising a plurality of pieces of sample network content, and the plurality of pieces of sample network content comprising positive samples corresponding to clicked pieces of sample network content and negative samples corresponding to not clicked pieces of sample network content;
determining a target quantity based on a quantity of the positive samples in the plurality of pieces of sample network content;
performing, by using an auxiliary model that is to be trained, a duration label prediction on selected negative samples of the target quantity from the training sample set to obtain dummy duration labels respectively associated with the selected negative samples, a dummy duration label associated with a negative sample in the selected negative samples indicating a prediction of whether a browsing duration of the negative sample after the negative sample is clicked is greater than a duration threshold;
acquiring true duration labels respectively associated with the plurality of pieces of sample network content, a true duration label associated with a piece of sample network content in the plurality of pieces of sample network content indicating whether a browsing duration of the piece of sample network content after the piece of sample network content is clicked is greater than the duration threshold; and
training a duration prediction model and the auxiliary model based on the selected negative samples, the dummy duration labels respectively associated with the selected negative samples, the plurality of pieces of sample network content, and the true duration labels respectively associated with the plurality of pieces of sample network content, the duration prediction model being configured to predict a probability that a browsing duration of a to-be-evaluated piece of sample network content after the to-be-evaluated piece of sample network content is clicked is greater than the duration threshold.

2. The method according to claim 1, wherein the training the duration prediction model and the auxiliary model comprises:
training the auxiliary model and the duration prediction model based on at least a first positive sample in the positive samples and a true duration label associated with the first positive sample;
training the duration prediction model based on at least a first negative sample in the negative samples and a true duration label associated with the first negative sample; and
training the duration prediction model based on at least a second negative sample in the selected negative samples and a dummy duration label associated with the second negative sample.

3. The method according to claim 2, wherein the training the auxiliary model and the duration prediction model based on at least the first positive sample and the true duration label associated with the first positive sample comprises:
performing, by using the auxiliary model, a duration label prediction for the first positive sample to obtain a dummy duration label associated with the first positive sample;
performing, by using the duration prediction model, a duration label prediction for the first positive sample to obtain a predicted duration label associated with the first positive sample, the predicted duration label associated with the first positive sample indicating a prediction of whether a browsing duration of the first positive sample after the first positive sample is clicked is greater than the duration threshold;
determining a first difference between the dummy duration label associated with the first positive sample and the true duration label associated with the first positive sample;
training the auxiliary model based on the first difference;
determining a second difference between the predicted duration label associated with the first positive sample and the true duration label associated with the first positive sample; and
training the duration prediction model based on the second difference.

4. The method according to claim 3, wherein the performing, by using the duration prediction model, the duration label prediction for the first positive sample comprises:
performing, by using the duration prediction model, a probability prediction for the first positive sample to obtain a duration prediction probability of the first positive sample, the duration prediction probability of the first positive sample indicating a probability that the browsing duration of the first positive sample is greater than the duration threshold;
performing, by using a click prediction model, a click-through rate prediction on the first positive sample to obtain a click-through rate of the first positive sample, the click-through rate of the first positive sample indicating a probability that the first positive sample is clicked, and the click prediction model being configured to predict a probability that a piece of sample network content is clicked;
determining a joint probability of the first positive sample according to the click-through rate of the first positive sample and the duration prediction probability of the first positive sample, the joint probability of the first positive sample indicating a probability that the first positive sample is clicked and the browsing duration of the first positive sample is greater than the duration threshold; and
determining the predicted duration label associated with the first positive sample according to the joint probability of the first positive sample.

5. The method according to claim 2, wherein the training the duration prediction model based on the first negative sample and the true duration label associated with the first negative sample comprises:
performing, by using the duration prediction model, a duration label prediction for the first negative sample to obtain a predicted duration label of the first negative sample, the predicted duration label of the first negative sample indicating a prediction of whether a browsing duration of the first negative sample after the first negative sample is clicked is greater than the duration threshold;
determining a third difference between the predicted duration label of the first negative sample and a dummy duration label associated with the first negative sample; and
training the duration prediction model based on the third difference.

6. The method according to claim 5, wherein the performing, by using the duration prediction model, the duration label prediction comprises:
performing, by using the duration prediction model, a probability prediction for the first negative sample to obtain a duration prediction probability of the first negative sample, the duration prediction probability of the first negative sample indicating a probability that the browsing duration of the first negative sample is greater than the duration threshold;
predicting, by using a click prediction model, a click-through rate of the first negative sample, the click-through rate of the first negative sample indicating a probability that the first negative sample is clicked, and the click prediction model being configured to predict a probability that a piece of sample network content is clicked;
determining a joint probability of the first negative sample according to the click-through rate of the first negative sample and the duration prediction probability of the first negative sample, the joint probability of the first negative sample indicating a probability that the first negative sample is clicked and the browsing duration of the first negative sample is greater than the duration threshold; and
determining the predicted duration label of the first negative sample according to the joint probability of the first negative sample.

7. The method according to claim 1, further comprising:
for a new piece of sample network content:
predicting, by using a click prediction model, a click-through rate of the new piece of sample network content;
when the click-through rate is less than a click threshold and the new piece of samples network content is a negative sample, assigning a value to a true duration label of the new piece of sample network, the value representing that a browsing duration of the new piece of sample network content is less than the duration threshold; and
adding the new piece of sample network content with the true duration label being assigned of the value to training sample set.

8. The method according to claim 1, further comprising:
training a click prediction model based on the plurality of pieces of sample network content and the true duration labels of the plurality of pieces of sample network content.

9. The method according to claim 1, wherein a structure of the duration prediction model is identical to a structure of the auxiliary model.

10. The method according to claim 1, wherein the auxiliary model is trained based on the positive samples in the training sample subset, and the duration prediction model is trained based on the plurality of pieces of sample network content in the training sample subset and the negative samples of the target quantity in the training sample subset.

11. An apparatus of duration prediction model training, comprising processing circuitry configured to:
acquire at least a training sample subset from a training sample set, the training sample subset comprising a plurality of pieces of sample network content, and the plurality of pieces of sample network content comprising positive samples corresponding to clicked pieces of sample network content and negative samples corresponding to not clicked pieces of sample network content;
determine a target quantity based on a quantity of the positive samples in the plurality of pieces of sample network content;
perform, by using an auxiliary model that is to be trained, a duration label prediction on selected negative samples of the target quantity from the training sample set to obtain dummy duration labels respectively associated with the selected negative samples, a dummy duration label associated with a negative sample in the selected negative samples indicating a prediction of whether a browsing duration of the negative sample after the negative sample is clicked is greater than a duration threshold;
acquire true duration labels respectively associated with the plurality of pieces of sample network content, a true duration label associated with a piece of sample network content in the plurality of pieces of sample network content indicating whether a browsing duration of the piece of sample network content after the piece of sample network content is clicked is greater than the duration threshold; and
train a duration prediction model and the auxiliary model based on the selected negative samples, the dummy duration labels respectively associated with the selected negative samples, the plurality of pieces of sample network content, and the true duration labels respectively associated with the plurality of pieces of sample network content, the duration prediction model being configured to predict a probability that a browsing duration of a to-be-evaluated piece of sample network content after the to-be-evaluated piece of sample network content is clicked is greater than the duration threshold.

12. The apparatus according to claim 11, wherein the processing circuitry is configured to:
train the auxiliary model and the duration prediction model based on at least a first positive sample in the positive samples and a true duration label associated with the first positive sample;
train the duration prediction model based on at least a first negative sample in the negative samples and a true duration label associated with the first negative sample; and
train the duration prediction model based on at least a second negative sample in the selected negative samples and a dummy duration label associated with the second negative sample.

13. The apparatus according to claim 12, wherein the processing circuitry is configured to:
perform, by using the auxiliary model, a duration label prediction for the first positive sample to obtain a dummy duration label associated with the first positive sample;
perform, by using the duration prediction model, a duration label prediction for the first positive sample to obtain a predicted duration label associated with the first positive sample, the predicted duration label associated with the first positive sample indicating a prediction of whether a browsing duration of the first positive sample after the first positive sample is clicked is greater than the duration threshold;
determine a first difference between the dummy duration label associated with the first positive sample and the true duration label associated with the first positive sample;
train the auxiliary model based on the first difference;
determine a second difference between the predicted duration label associated with the first positive sample and the true duration label associated with the first positive sample; and
train the duration prediction model based on the second difference.

14. The apparatus according to claim 13, wherein the processing circuitry is configured to:
perform, by using the duration prediction model, a probability prediction for the first positive sample to obtain a duration prediction probability of the first positive sample, the duration prediction probability of the first positive sample indicating a probability that the browsing duration of the first positive sample is greater than the duration threshold;
perform, by using a click prediction model, a click-through rate prediction on the first positive sample to obtain a click-through rate of the first positive sample, the click-through rate of the first positive sample indicating a probability that the first positive sample is clicked, and the click prediction model being configured to predict a probability that a piece of sample network content is clicked;
determine a joint probability of the first positive sample according to the click-through rate of the first positive sample and the duration prediction probability of the first positive sample, the joint probability of the first positive sample indicating a probability that the first positive sample is clicked and the browsing duration of the first positive sample is greater than the duration threshold; and
determine the predicted duration label associated with the first positive sample according to the joint probability of the first positive sample.

15. The apparatus according to claim 12, wherein the processing circuitry is configured to:
perform, by using the duration prediction model, a duration label prediction for the first negative sample to obtain a predicted duration label of the first negative sample, the predicted duration label of the first negative sample indicating a prediction of whether a browsing duration of the first negative sample after the first negative sample is clicked is greater than the duration threshold;
determine a third difference between the predicted duration label of the first negative sample and a dummy duration label associated with the first negative sample; and
train the duration prediction model based on the third difference.

16. The apparatus according to claim 15, wherein the processing circuitry is configured to:
perform, by using the duration prediction model, a probability prediction for the first negative sample to obtain a duration prediction probability of the first negative sample, the duration prediction probability of the first negative sample indicating a probability that the browsing duration of the first negative sample is greater than the duration threshold;
predict, by using a click prediction model, a click-through rate of the first negative sample, the click-through rate of the first negative sample indicating a probability that the first negative sample is clicked, and the click prediction model being configured to predict a probability that a piece of sample network content is clicked;
determine a joint probability of the first negative sample according to the click-through rate of the first negative sample and the duration prediction probability of the first negative sample, the joint probability of the first negative sample indicating a probability that the first negative sample is clicked and the browsing duration of the first negative sample is greater than the duration threshold; and
determine the predicted duration label of the first negative sample according to the joint probability of the first negative sample.

17. The apparatus according to claim 11, wherein the processing circuitry is configured to:
for a new piece of sample network content:
predict, by using a click prediction model, a click-through rate of the new piece of sample network content;
when the click-through rate is less than a click threshold and the new piece of samples network content is a negative sample, assign a value to a true duration label of the new piece of sample network, the value representing that a browsing duration of the new piece of sample network content is less than the duration threshold; and
add the new piece of sample network content with the true duration label being assigned of the value to training sample set.

18. The apparatus according to claim 11, wherein the processing circuitry is configured to:
train a click prediction model based on the plurality of pieces of sample network content and the true duration labels of the plurality of pieces of sample network content.

19. The apparatus according to claim 11, wherein a structure of the duration prediction model is identical to a structure of the auxiliary model.

20. A non-transitory computer-readable storage medium storing instructions which when executed by at least one processor cause the at least one processor to perform:
acquiring at least a training sample subset from a training sample set, the training sample subset comprising a plurality of pieces of sample network content, and the plurality of pieces of sample network content comprising positive samples corresponding to clicked pieces of sample network content and negative samples corresponding to not clicked pieces of sample network content;
determining a target quantity based on a quantity of the positive samples in the plurality of pieces of sample network content;
performing, by using an auxiliary model that is to be trained, a duration label prediction on selected negative samples of the target quantity from the training sample set to obtain dummy duration labels respectively associated with the selected negative samples, a dummy duration label associated with a negative sample in the selected negative samples indicating a prediction of whether a browsing duration of the negative sample after the negative sample is clicked is greater than a duration threshold;
acquiring true duration labels respectively associated with the plurality of pieces of sample network content, a true duration label associated with a piece of sample network content in the plurality of pieces of sample network content indicating whether a browsing duration of the piece of sample network content after the piece of sample network content is clicked is greater than the duration threshold; and
training a duration prediction model and the auxiliary model based on the selected negative samples, the dummy duration labels respectively associated with the selected negative samples, the plurality of pieces of sample network content, and the true duration labels respectively associated with the plurality of pieces of sample network content, the duration prediction model being configured to predict a probability that a browsing duration of a to-be-evaluated piece of sample network content after the to-be-evaluated piece of sample network content is clicked is greater than the duration threshold.
